(19) United States
(12) Patent Application Publication
(10) Pub. No.: US 2022/0330519 A1
(43) Pub. Date: Oct. 20, 2022

(54) ELEVATABLE PET BED PLATFORM ASSEMBLY

(71) Applicants: John Chitkowski, Glen Ellen, IL (US); Kerry Chitkowski, Glen Ellen, IL (US)

(72) Inventors: John Chitkowski, Glen Ellen, IL (US); Kerry Chitkowski, Glen Ellen, IL (US)

(21) Appl. No.: 17/235,610

(22) Filed: Apr. 20, 2021

(51) Int. Cl. A01K 1/035; F16M 11/38

(52) U.S. Cl. CPC A01K 1/0353; F16M 11/38

(57) ABSTRACT

An elevatable pet bed platform assembly for elevating a pet bed to mattress level includes a box, which has a top that is open, and a lid. A lift module is positioned in the box and is operationally engaged to the box and the lid so that the lift module is positioned to selectively elevate the lid. A fastener engaged to an upper face of the lid selectively engages a pet bed. A set of steps is hingedly engaged to the lid. The steps of the set of steps are mutually hingedly engaged so that the set of steps can be extended from the lid to a surface upon which the box is positioned. The lift module selectively elevates the lid to mattress level, positioning the steps to be extended from the lid to the surface so that they can be traversed by a pet to access the pet bed.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM.

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to platform assemblies and more particularly pertains to a new platform assembly for elevating a pet bed to mattress level. The present invention discloses a platform assembly comprising a selectively extendible platform having an integral set of foldable steps, wherein the platform and the steps are configured to be stowed underneath a bed.

### (2) Description of Related Art including information disclosed under 37 CFR 1.97 and 1.98.

The prior art relates to platform assemblies. Prior art platform assemblies comprise module and fixed height platforms, which may have stairs for allowing pets access to the platforms. What is lacking in the prior art is a platform assembly comprising a selectively extendible platform having an integral set of foldable steps, wherein the platform and the steps are configured to be stowed underneath a bed.

### BRIEF SUMMARY OF THE INVENTION

An embodiment of the disclosure meets the needs presented above by generally comprising a box, which has a top that is open. A lid is selectively positionable on the box to close the top. A lift module is positioned in the box and is operationally engaged to the box and the lid so that the lift module is positioned to selectively elevate the lid. A fastener is engaged to an upper face of the lid and is configured to selectively engage a pet bed so that the pet bed is removably engaged to the lid. A set of steps is hingedly engaged to the lid. The steps of the set of steps are mutually hingedly engaged so that the set of steps is selectively positionable in an extended configuration and a stowed configuration. In the extended configuration, the steps extend stepwise from the lid to a surface upon which the box is positioned. In the stowed configuration, the steps of the set of steps are substantially parallel and abutting. The lift module is configured to selectively elevate the lid, positioning the steps to be extended from the lid to the surface. The steps thus are configured to be traversed by a pet to access the pet bed.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of an elevatable pet bed platform assembly according to an embodiment of the disclosure.

FIG. 2 is an isometric perspective view of an embodiment of the disclosure.

FIG. 3 is a front view of an embodiment of the disclosure.

FIG. 4 is a side view of an embodiment of the disclosure.

FIG. 5 is a top view of an embodiment of the disclosure.

FIG. 6 is a side view of an embodiment of the disclosure.

FIG. 7 is an in-use view of an embodiment of the disclosure.

### DETAILED DESCRIPTION OF THE INVENTION

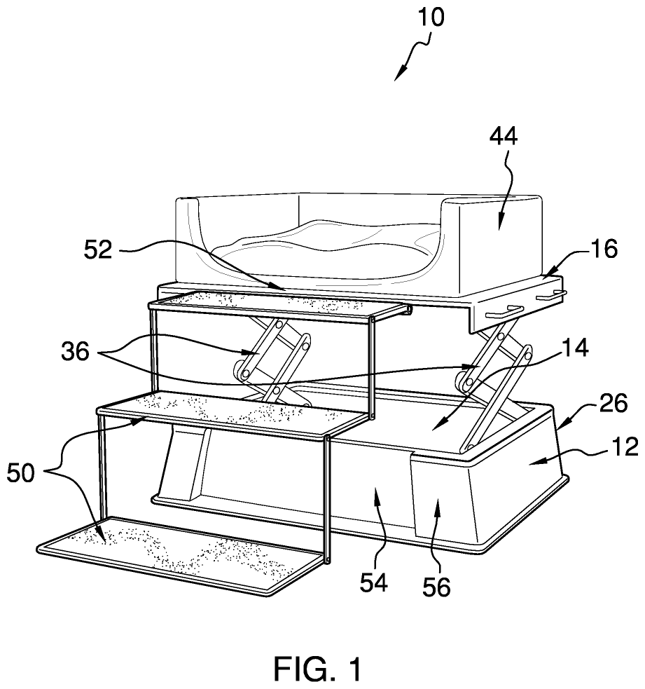

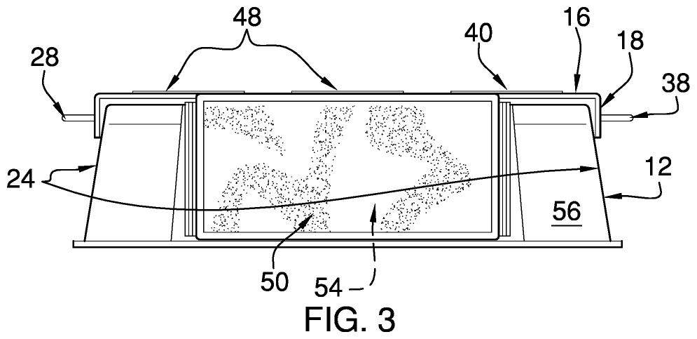

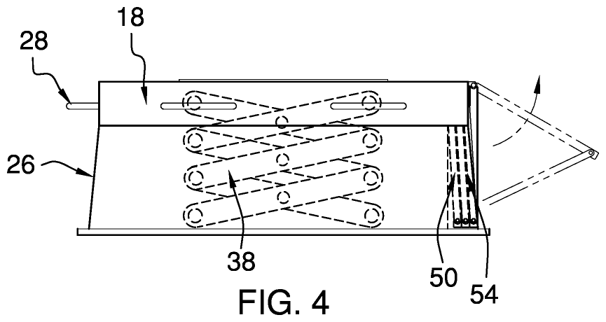

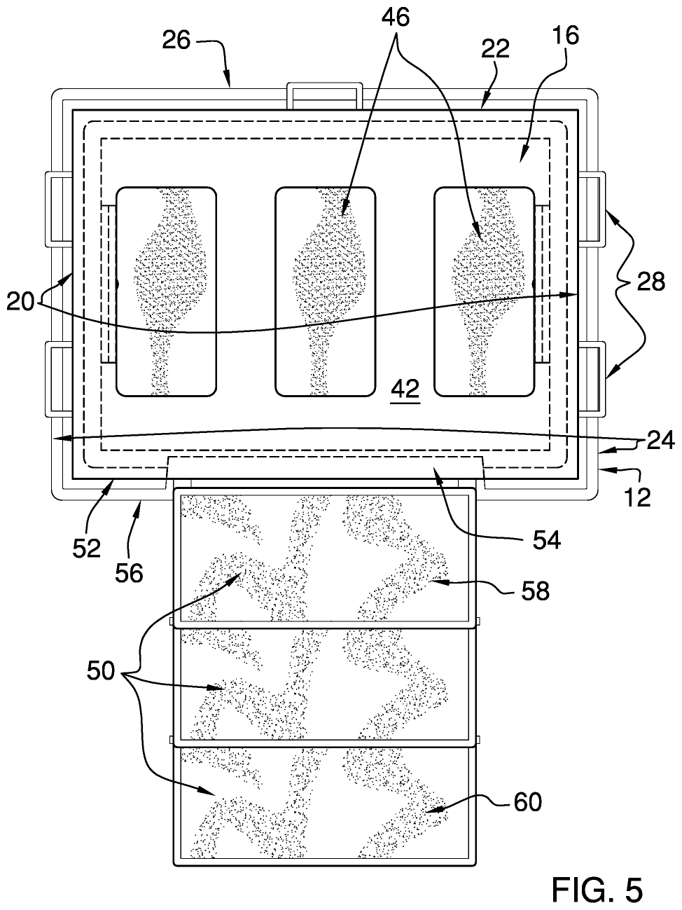

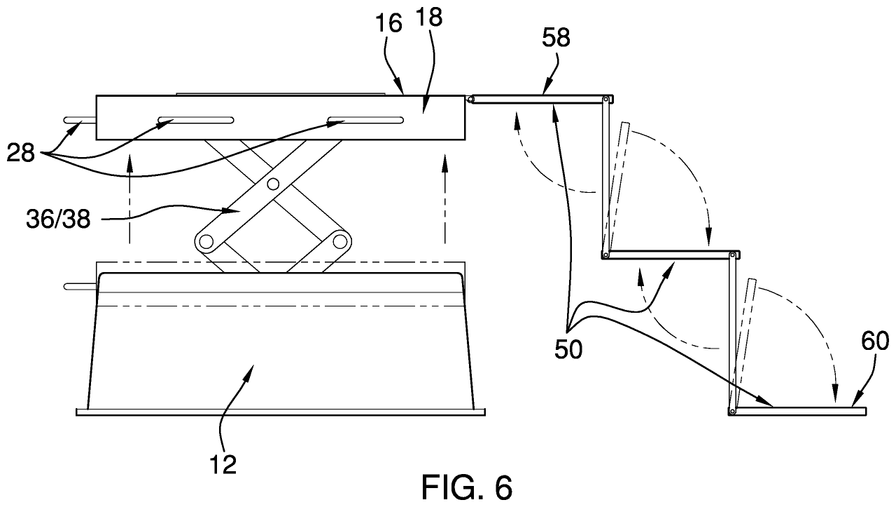

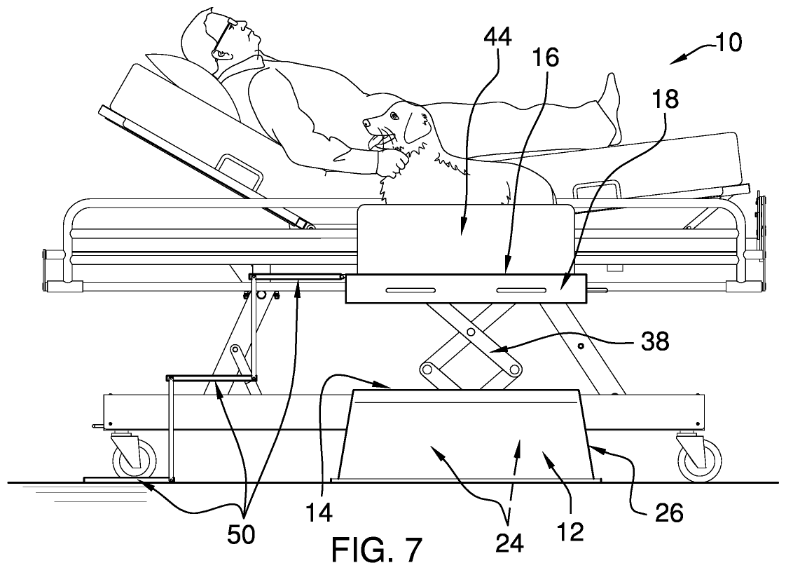

With reference now to the drawings, and in particular to FIGS. 1 through 7 thereof, a new platform assembly embodying the principles and concepts of an embodiment of the disclosure and generally designated by the reference numeral 10 will be described.

As best illustrated in FIGS. 1 through 7, the elevatable pet bed platform assembly 10 generally comprises a box 12, which has a top 14 that is open. A lid 16 is selectively positionable on the box 12 to close the top 14. A lip 18 is engaged to and extends substantially perpendicularly from opposed sides 20 and a back 22 of the lid 16. The lip 18 overlays opposing sides 24 and a rear 26 of the box 12 when the lid 16 is positioned on the box 12.

A set of handles 28 is engaged to the lip 18. A respective handle 28 is configured to be grasped in a hand of a user, positioning the user to lift or to position the box 12 and the lid 16. The set of handles 28 may comprise five handles 28 positioned two apiece proximate to each opposed side 20 and singly proximate to the back 22 of the lid 16. The present invention also anticipates the handles 28 being engaged to the box 12, and the set of handles 28 comprising one, two, three, or four handles 28.

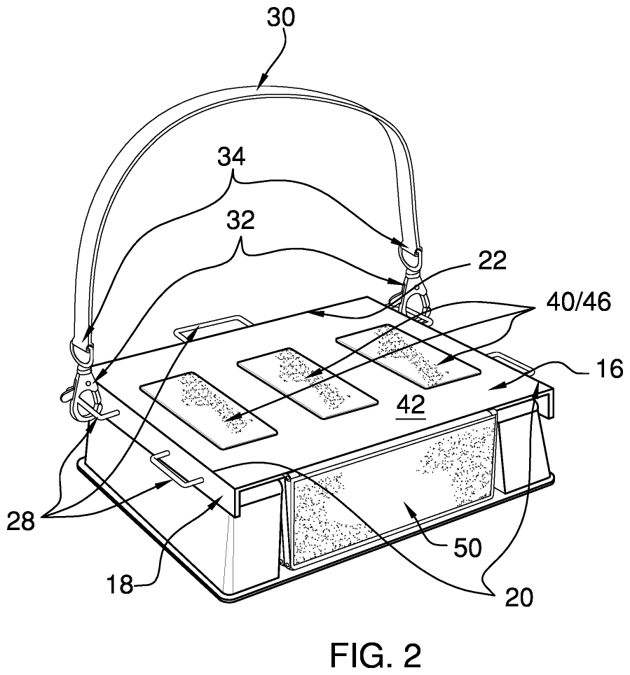

The elevatable pet bed platform assembly 10 also may comprise a strap 30 having a pair of connectors 32 engaged singly to its opposed ends 34. Each connector 32 is configured to selectively engage a respective handle 28, so that the strap 30 is loopedly engaged to the lip 18, as shown in FIG. 2. The strap thus is configured to be positioned over a shoulder of a user enabling the user to carry the box 12 and the lid 16.

A lift module 36 is positioned in the box 12 and is operationally engaged to the box 12 and the lid 16 so that the lift module 36 is positioned to selectively elevate the lid 16. The lift module 36 may comprise a pair of scissor lifts 38 positioned singly proximate the opposed sides 20 of the lid 16, or other lifting means, such as, but not limited to, screw jacks, hydraulic cylinders, and the like. The present invention also anticipates the pair of scissor lifts 38 being operationally engaged to and actuated by motors, linear actuators, and the like.

A fastener 40 is engaged to an upper face 42 of the lid 16 and is configured to selectively engage a pet bed 44 so that the pet bed 44 is removably engaged to the lid 16. The fastener 40 may comprise one or both of a set of pads 46, as shown in FIG. 2, and a set of hook and loop first elements 48. The pads 46 are resiliently compressible and thus are configured to frictionally engage an underside of the pet bed 44. Each hook and loop first element 48 is configured to engage a respective hook and loop second element, which is engaged to the underside of the pet bed 44. The present invention also anticipates the fastener 40 comprising other fastening means, such as, but not limited to, pressure sensitive adhesives, straps, magnets, and the like.

A set of steps 50 is hingedly engaged to the lid 16. The steps 50 of the set of steps 50 are mutually hingedly engaged so that the set of steps 50 is selectively positionable in an extended configuration, as shown in FIG. 1, and a stowed configuration, as shown in FIG. 2. In the extended configuration, the steps 50 extend stepwise from the lid 16 to a surface upon which the box 12 is positioned. In the stowed configuration, the steps 50 of the set of steps 50 are substantially parallel and abutting. The lift module 36 is configured to selectively elevate the lid 16, positioning the steps 50 to be extended from the lid 16 to the surface. The steps 50 thus are configured to be traversed by a pet to access the pet bed 44.

The present invention is anticipated to be useful to a user who wants their pet near them when the user is in bed, without having the pet in bed with them. The elevatable pet bed platform assembly 10 can be stowed underneath the bed when not in use and is readily transportable for use in alternate locations.

The set of steps 50 may be engaged to a front 52 of the lid 16, as shown in FIG. 1, although the present invention also anticipates the set of steps 50 being engaged to a respective opposed side 20 of the lid 16. The set of steps 50, when in the stowed configuration, is positioned in a recess 54, which extends into a forward face 56 of the box 12. The set of steps 50 may comprise three steps 50, as shown in FIG. 1, or other number of steps 50, such as two, four or five steps 50. The steps 50 may lack risers, as shown in FIG. 1, although the present invention also anticipates the steps 50 comprising risers (not shown).

An uppermost step 58 may be substantially coplanar with the lid 16, as shown in FIG. 1, although the present invention also anticipates the uppermost step 58 being positioned below the lid 16. A lowermost step 60 may be positioned flush with the surface upon which the box 12 is positioned, as shown in FIG. 1, although the present invention also anticipates the lowermost step 60 being elevated relative to the surface.

In use, the box 12 is positioned proximate to a side of a bed and the lid 16 is extended upon the pair of scissor jacks 38 to a desired height. The steps 50 then are extended from the lid 16 to the surface. The pet bed 44 is positioned on the upper face 42 of the lid 16 and is held in place by the pads 46. The pet then can traverse the steps to access the pet bed 44.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An elevatable pet bed platform assembly comprising:
a box, the box having a top, the top being open;
a lid selectively positionable on the box for closing the top;
a lift module positioned in the box and being operationally engaged to the box and the lid, such that the lift module is positioned for selectively elevating the lid;
a fastener engaged to an upper face of the lid and being configured for selectively engaging a pet bed, such that the pet bed is removably engaged to the lid, wherein the fastener is configured for engaging the pet bed for removably engaging the pet bed to the lid; and
a set of steps hingedly engaged to the lid, the steps of the set of steps being mutually hingedly engaged, such that the set of steps is selectively positionable in an extended configuration, wherein the steps extend stepwise from the lid to a surface upon which the box is positioned, and a stowed configuration, wherein the steps of the set of steps are substantially parallel and abutting, wherein the lift module is configured for selectively elevating the lid, positioning the steps for being extended from the lid to the surface, wherein the steps are configured for being traversed by a pet for accessing the pet bed.

2. The elevatable pet bed platform assembly of claim 1, further including a lip engaged to and extending substantially perpendicularly from opposed sides and a back of the lid, such that the lip overlays opposing sides and a rear of the box when the lid is positioned on the box.

3. The elevatable pet bed platform assembly of claim 2, further including a set of handles engaged to the lip, wherein a respective handle is configured for grasping in a hand of a user, positioning the user for lifting or positioning the box and the lid.

4. The elevatable pet bed platform assembly of claim 3, wherein the set of handles comprises five handles positioned two apiece proximate to each opposed side and singly proximate to the back of the lid.

5. The elevatable pet bed platform assembly of claim 1, wherein the lift module comprises a pair of scissor lifts positioned singly proximate the opposed sides of the lid.

6. The elevatable pet bed platform assembly of claim 1, wherein the fastener comprises one or both of a set of pads and a set of hook and loop first elements, the pads being resiliently compressible, wherein the pads are configured for frictionally engaging an underside of the pet bed, wherein each of the hook and loop first elements is configured for engaging a respective hook and loop second element engaged to the underside of the pet bed,

7. The elevatable pet bed platform assembly of claim 1, wherein the set of steps comprises three steps.

8. The elevatable pet bed platform assembly of claim 1, wherein:
the set of steps is engaged to a front of the lid; and
the set of steps is positioned in a recess extending into a forward face of the box when the set of steps is in the stowed configuration.

9. The elevatable pet bed platform assembly of claim 3, further including:
a strap; and
a pair of connectors engaged singly to opposed ends of the strap, each connector being configured for selectively engaging a respective handle, such that the strap is loopedly engaged to the lip, wherein the strap is configured for positioning over a shoulder of the user for carrying the box and the lid.

10. An elevatable pet bed platform system comprising:
a pet bed;
a box, the box having a top, the top being open;
a lid selectively positionable on the box for closing the top, the pet bed being engaged to an upper face of the lid;
a lift module positioned in the box and being operationally engaged to the box and the lid, such that the lift module is positioned for selectively elevating the lid; and
a set of steps hingedly engaged to the lid, the steps of the set of steps being mutually hingedly engaged, such that the set of steps is selectively positionable in an extended configuration, wherein the steps extend stepwise from the lid to a surface upon which the box is positioned, and a stowed configuration, wherein the steps of the set of steps are substantially parallel and abutting, positioning the steps for being extended from the lid to the surface, wherein the steps are configured for being traversed by a pet for accessing the pet bed.

11. An elevatable pet bed platform assembly comprising:
a box, the box having a top, the top being open;
a lid selectively positionable on the box for closing the top;
a lip engaged to and extending substantially perpendicularly from opposed sides and a back of the lid, such that the lip overlays opposing sides and a rear of the box when the lid is positioned on the box;
a set of handles engaged to the lip, wherein a respective handle is configured for grasping in a hand of a user, positioning the user for lifting or positioning the box and the lid, the set of handles comprising five handles positioned two apiece proximate to each opposed side and singly proximate to the back of the lid;
a lift module positioned in the box and being operationally engaged to the box and the lid, such that the lift module is positioned for selectively elevating the lid, the lift module comprising a pair of scissor lifts positioned singly proximate the opposed sides of the lid;
a fastener engaged to an upper face of the lid and being configured for selectively engaging a pet bed, such that the pet bed is removably engaged to the lid, wherein the fastener is configured for engaging the pet bed for removably engaging the pet bed to the lid, the fastener comprising one or both of a set of pads and a set of hook and loop first elements, the pads being resiliently compressible, wherein the pads are configured for frictionally engaging an underside of the pet bed, wherein each of the hook and loop first elements is configured for engaging a respective hook and loop second element engaged to the underside of the pet bed;
a set of steps hingedly engaged to the lid, the steps of the set of steps being mutually hingedly engaged, such that the set of steps is selectively positionable in an extended configuration, wherein the steps extend stepwise from the lid to a surface upon which the box is positioned, and a stowed configuration, wherein the steps of the set of steps are substantially parallel and abutting, wherein the lift module is configured for selectively elevating the lid, positioning the steps for being extended from the lid to the surface, wherein the steps are configured for being traversed by a pet for accessing the pet bed, the set of steps being engaged to a front of the lid, the steps set of being positioned in a recess extending into a forward face of the box when the set of steps is in the stowed configuration, the set of steps comprising three steps;
a strap; and
a pair of connectors engaged singly to opposed ends of the strap, each connector being configured for selectively engaging a respective handle, such that the strap is loopedly engaged to the lip, wherein the strap is configured for positioning over a shoulder of the user for carrying the box and the lid.
